(19) United States
(12) Patent Application Publication
(10) Pub. No.: US 2007/0121798 A1
(43) Pub. Date: May 31, 2007

(54) Public service answering point (PSAP) proxy

(76) Inventors: Jon Croy, Seattle, WA (US); John Gordon Hines, Kirkland, WA (US); Darrin Johnson, Monroe, WA (US)

Correspondence Address: MENELLI DENISON & SELTER PLLC, 7th Floor, 2000 M Street, N.W., Washington, DC, 20036-3307, US

(21) Appl. No.: 11/472,308

(22) Filed: Jun. 22, 2006

Related U.S. Application Data
(60) Provisional application No. 60/728,326, filed on Oct. 20, 2005.

(51) Int. Cl. H04M 11/04; H04L 12/66

(52) U.S. Cl. 379/37; 370/352

(57) ABSTRACT

A “PSAP Proxy”, including VoIP functions of call/content delivery to a PSAP, is IP addressable by multiple different VPCs, from multiple VoIP service providers. If the PSAP address is known and the Location Object (LO) is known when a VoIP caller dials 911, the VoIP service provider's softswitch sends the call to the PSAP Proxy for delivery over the determined call access type. If the PSAP address or LO is not known when a VoIP caller dials 911, the softswitch sends the VoIP call to a VPC for addition of the LO. Then the VPC selects the correct PSAP Proxy and passes the call, with LO, over an IP connection to the correct PSAP Proxy. The PSAP Proxy determines capability of the PSAP, and delivers the call. Thus, PSAPs appear IP capable to VoIP service providers, and a SIP URI is provided for PSAPs.

### BACKGROUND OF THE INVENTION

1. Field of the Invention

This invention relates generally to telecommunication. More particularly, it relates to location based services for the provision of E-9-1-1 emergency services using Voice Over Internet Protocol (VoIP) protocols and architectures.

2. Background of the Related Art

911 is a phone number widely recognized in North America as an emergency phone number that is used to contact emergency dispatch personnel. Enhanced 911 (E911) is defined by the transmission of callback number and location information. E911 may be implemented for landline, cellular and/or VoIP.

A Public Service Answering Point (PSAP) is a dispatch office that receives 9-1-1 calls from the public. A PSAP may be a local, fire or police department, an ambulance service or a regional office covering all services. A 9-1-1 (“911”) service becomes E-9-1-1 (“E911”) when automatic number identification and automatic location information related to the call is provided to the 911 operator.

Voice-Over-Internet Protocol (VoIP) is a technology that emulates a traditional phone call, but instead of using a circuit based system such as the telephone network, it utilizes packetized data transmission techniques most notably implemented in the Internet. 911 calls made using VoIP technology must reach the correct PSAP, but there currently is no uniform interface to the various PSAPs for call delivery because the technology for connecting calls varies. For instance, some PSAPs are Internet Protocol (IP) capable. Some PSAPs are accessed via ordinary Public Switched Telephone Network (PSTN) telephone lines. Some PSAPs are accessed through selective routing such as direct trunks. There is no uniformity among the thousands of different PSAPs.

Moreover, some Public Safety Access Points (PSAPs) are not enhanced, and thus do not receive the callback or location information at all from any phone; landline, cellular or VoIP.

The existing E911 infrastructure is built upon copper wire line voice technology and is not fully compatible with VoIP. Given VoIP technology, there are at least three VoIP scenarios that require E911 service:
1. A VoIP UA that is physically connected to a static data cable at a “home” address. For instance, an Analog Telephone Adapter (ATA) that is connected to the “home” data cable and uses traditional telephone devices.
2. A VoIP UA that is physically connected to a data cable at a location different than its “home” address. For instance, a laptop computer device utilized away from home as a VoIP software telephone would be a VoIP ‘visitor’ device as described by this scenario.
3. A VoIP UA that is wireleless, physically disconnected from any data cable. In this situation, the VoIP UA connects to the VoIP service provider via either a wide-are wireless technology (e.g., cellular, PCS, WiMAX) or via a local-area wireless technology (e.g., Wireless Fidelity (WiFi), UWB, etc.) using a laptop computer or handheld device.

In the current state of technology, VoIP 911 call-routing relies on a VoIP Positioning Center (VPC) to receive VoIP 911 calls, determine the location of the VoIP caller (through prior location provisioning, or passing location with call signaling), determine the correct PSAP for that location and determine how that PSAP can receive VoIP calls (e.g. over PSTN, over Selective Router, or over VoIP). Additionally, the VPC is responsible for interaction with the PSAP's ALI, handling the various ALI protocols. (ALI is a database that relates a specific telephone number to an address. This database accepts a PSAP query with a telephone number and responds with an address. In the case of an Emergency Services Query Key (ESQK), the ALI database steers the query to the appropriate VPC and steers the response back to the PSAP. An ESQK is a digit string that uniquely identifies an ongoing emergency services call and is used to correlate the emergency services call with the associated data messages. It may also identify an emergency services zone and may be used to route the call through the network. Similar to an Emergency Services Routing Key (ESRK) in wireless E9-1-1 networks.) A VoIP Positioning Center is acting as a “Swiss Army Knife” of VoIP Emergency Service.

Moreover, there is complexity in public access to Public Safety Answering Points due to lack of a Session Initiation Protocol (SIP) Uniform Resource Identifier (URI) for all PSAPs. (SIP is the IP-based protocol defined in IETF RFCs 3261 and 2543. SIP is one of two dominant protocols used by the VoIP industry. URI is the addressing technology for identifying resources on the Internet or a private intranet. URIs were originally defined as two types: Uniform Resource Locators (URLs) which are addresses with network location, and Uniform Resource Names (URNs) which are persistent names that are address independent. Today, a URI is defined by its purpose rather than the URL vs. URN classification.) Some PSAPs are accessed only by conventional telephone line, others only by direct telephone trunk lines. Not all PSAPs are accessible via the Internet.

FIG. 3 shows basic conventional VoIP elements required to interconnect a VoIP emergency E911 caller to a relevant public safety access point (PSAP).

In particular, as shown in FIG. 3, VoIP telephone devices 102a, 102b, 102c (collectively referred to as 102) are connected to respective VoIP Service Provider (VSP) soft switches 104a, 104b, 104c (collectively referred to as 104) using an Internet Protocol (IP) connection, most commonly over the Internet. The VoIP service provider's soft switch 104 in turn communicates with a respective VoIP Positioning Center (VPC) 106a, 106b, 106c (collectively referred to as 106) using an appropriate IP connection. Each VSP requires use of their own VPC, as depicted in FIG. 3.

FIG. 4 shows in more detail conventional VoIP elements required by a VPC to interconnect a VoIP emergency E911 caller to a relevant public safety access point (PSAP).

In particular, as shown in FIG. 4, each VPC 106 comprises its own respective route determination module 404, call delivery module 406, and provisioning list 408.

A respective location information server (LIS) 108 services each of the VPCs 106. The LIS 108 is responsible for storing and providing access to the subscriber location information needed for E9-1-1 call processing (as defined by the NENA VoIP Location Working Group).

A conventional VoIP Positioning Center (VPC) 106 is a system that attempts to determine the appropriate or correct PSAP 114 that a VoIP emergency E911 call should be routed to based on the VoIP subscriber's position. The conventional VPC 106 also returns associated routing instructions to the VoIP network. The conventional VPC 106 additionally provides the caller's location and the callback number to the relevant PSAP through the automatic location identifier (ALI) (The ALI is a database that accepts a PSAP query, and using that relates a specific telephone number to a street address. In the case of an Emergency Services Query Key (ESQK), the ALI database steers the query to the appropriate VPC and steers the response back to the PSAP. An ALI is typically owned by a LEC or a PSAP.)

Further as shown in FIG. 4, each VSP route the emergency 9-1-1 call, without location object added, to their VPC 106. The VPC must determine the correct PSAP 114 (collectively represented by PSAP 114a, 114b and 114c) and route to it using the appropriate technology.

In a first scenario, the VPC 106 passes the 9-1-1 call to the PSAP 114a using an INVITE telephone number message, via a media gateway 110 that translates between the IP protocol of the INVITE message and a telephone line interface, and interfaces with the public switched telephone network (PSTN) 112.

In a second scenario, the VPC 106 passes the 9-1-1 call to the PSAP 114b using an INVITE S/R message, via an ESGW 120 and selective router 122. In this scenario, the selective router 122 is connected to the relevant PSAP 114b via direct trunks.

In a third scenario, the VPC 106 passes the 9-1-1 call to the PSAP 114c using an INVITE PSAP message, via IP, to the PSAP 114c.

In the second and third scenario, the ALI 126 must be inter-connected with each VPC 106 (a,b,c). Furthermore, each VPC is burdened with supporting all the various ALI protocols: ve2, e2, PAM, legacy NENA, etc.

Thus, each VoIP service provider requires its own VPC 106 comprising multiple elements (route determination module 404, call delivery module 406, and provisioning list 408). Conventional VPCs used by any given VoIP service provider are required to handle many aspects of routing an emergency VoIP E911 call to the relevant PSAP and providing ALI information to the PSAP, creating an expensive and highly complex architecture all in one place. The complexity is compounded by the fact that many (if not most) PSAPs are not capable of being accessed by an emergency VoIP E911 call via Internet Protocol (IP). Moreover, each VoIP service provider, of which there are many, must implement their own VPC, causing wasteful inefficiencies in the system architecture as appreciated by the present inventors. This makes the conventional VPC difficult to manage since it accomplishes not only route determination using the route determination module 404, but also delivery of calls using a call delivery module 406, and additionally serves to maintain a provisioning list 408 (i.e., interface type) for accessing each PSAP. This in turn causes great complexity in public access to PSAPs, depending upon various entities in the VoIP world to know the capabilities of each particular PSAP throughout the region, state, or even country.

There is a need for an architecture and methodology that both simplifies the complexity of a voice positioning center (VPC), and which also increases system efficiencies.

### SUMMARY OF THE INVENTION

In accordance with the principles of the present invention, a voice over Internet Protocol (VoIP) emergency call is delivered to a public safety access point (PSAP) by determining a route of a VoIP emergency call. An INVITE message including a location object relating to a caller of said VoIP emergency call is passed over a connection utilizing Session Initiation Protocol (SIP). Upon receipt of the passed INVITE message, a provisioning is looked up of the PSAP for accessing the PSAP with the VoIP emergency call. The INVITE message is delivered to the PSAP using an appropriate interface designated by the looked up access technology provisioned.

In accordance with the principles of the invention, a new VoIP element called a “PSAP Proxy” is introduced. The PSAP Proxy's role in VoIP E-9-1-1 is to represent the PSAP as a VoIP entity to the VoIP Service Provider. For the PSAP the PSAP Proxy represents ALI delivery over IP to the IP capable PSAP and a common protocol platform for access to traditional ALI databases.

From the VoIP networks' perspective, the PSAP Proxy makes it appear as if each PSAP is VoIP enabled. The PSAP Proxy takes over the burden from the VPC of delivering the call to the PSAP via whatever technology is required to route calls to the PSAP (e.g. PSTN, dedicated trunks, VoIP).

From the VPC ALI networks' perspective, the PSAP Proxy makes it appear as if each PSAP is ve2 enabled (ve2 is the current NENA VoIP standard ALI interface). The PSAP Proxy takes over the burden from the VPC of delivering ALI information to the PSAP via whatever technology or protocol the PSAP's ALI requires.

### BRIEF DESCRIPTION OF THE DRAWINGS

FIG. 1 shows the implementation of a PSAP proxy in an IP network, in accordance with the principles of the present invention.

FIG. 2 shows in more detail the implementation of a PSAP proxy in an IP network as shown in FIG. 1.

FIG. 3 shows basic conventional VoIP elements required to interconnect a VoIP emergency E911 caller to a relevant public safety access point (PSAP).

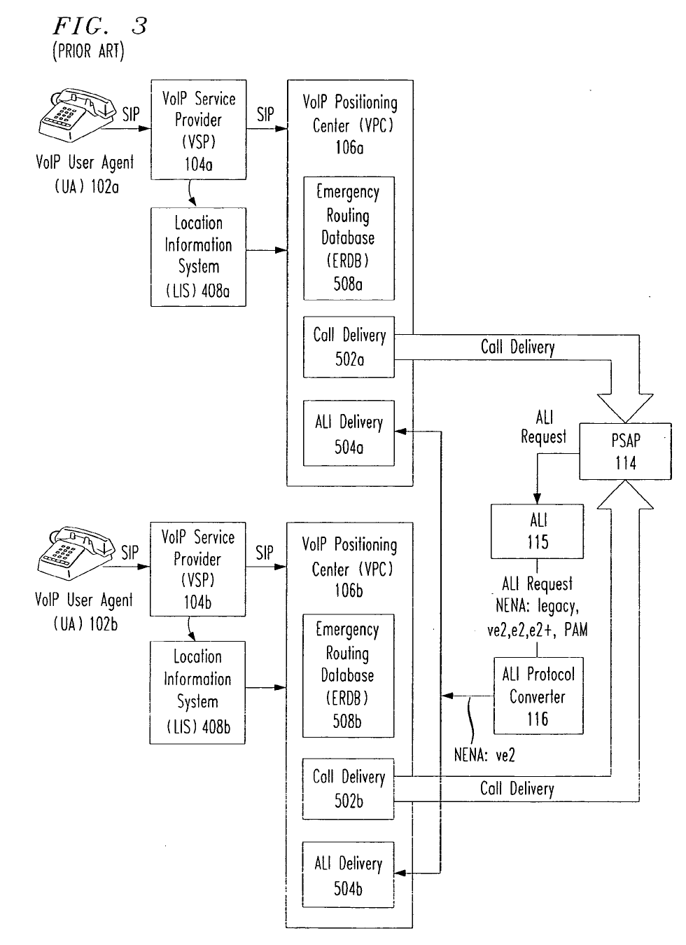

FIG. 4 shows in more detail conventional VoIP elements required to interconnect a VoIP emergency E911 caller to a relevant public safety access point (PSAP).

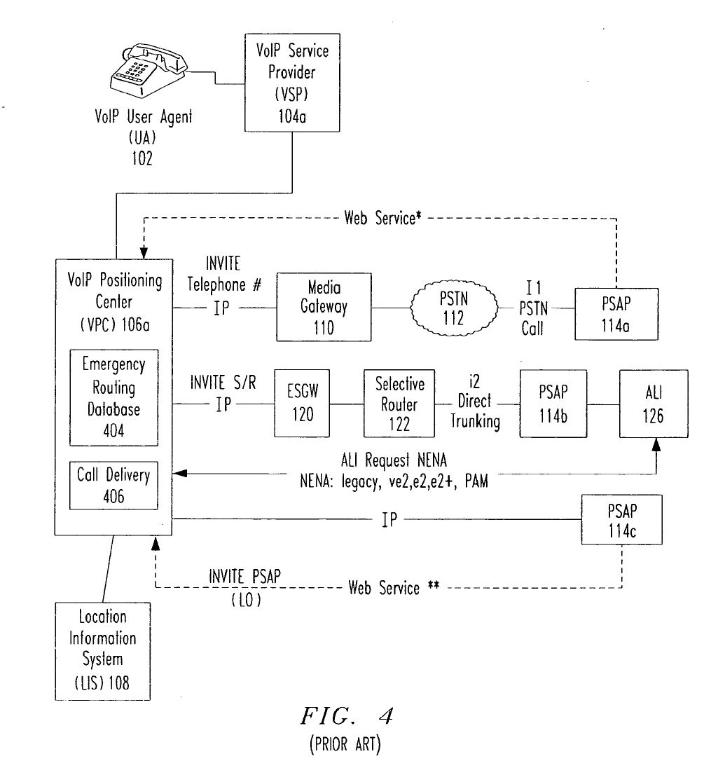

### DETAILED DESCRIPTION OF ILLUSTRATIVE EMBODIMENTS

The present invention implements VoIP functions of call delivery and content delivery (e.g, ALI) in a separate network entity referred to herein as a “PSAP Proxy”. A PSAP Proxy is a unit that handles delivery of a VoIP call to a correct PSAP. A PSAP Proxy also provides VoIP call ALI information to the PSAP. The PSAP Proxy is separately IP addressable by multiple different VPCs, potentially from multiple VoIP service providers, providing greater network simplicity and efficiency than is provided by conventional network architectures.

When a Voice Over Internet Protocol (VoIP) caller dials 9-1-1, the VoIP Service Provider's Soft Switch sends the VoIP call to a VPC for addition of a Location Object (LO). Then, based on the position of the caller determined by the location object, the VPC selects the correct PSAP Proxy and passes the E911 emergency call, with location object, over an Internet Protocol connection to the correct PSAP Proxy. The PSAP proxy, accepting an IP input from the VPC, handles delivery of the emergency VoIP call to the PSAP using the best available technology to interconnect with the PSAP. In this way, the PSAP Proxy in accordance with the present invention makes all PSAPs appear IP capable to the VoIP service providers, and provides a SIP URI for all PSAPs. The PSAP Proxy communicates with any other components or entities required to process the call (e.g., Selective Router, PSTN, PSAP). When the PSAP requests ALI information from the PSAP Proxy the PSAP Proxy will handle protocol conversions between the existing ALI protocols (ve2, e2, e2+, PAM, legacy NENA, etc.) to NENA ve2 or NENA e2 used to communicate with a VPC.

The PSAP Proxy technique as disclosed and taught herein provides VoIP service providers and VoIP positioning centers with the ability to deliver calls and automatic location identifier (ALI) information to PSAPs with the PSAP Proxy.

Moreover, a PSAP proxy in accordance with the principles of the present invention allows local exchange carriers (LECs) and Competitive Local Exchange Carriers (CLECs) the ability to collect inbound calls for routing via their public switched telephone network (PSTN) and emergency service network to the PSAPs.

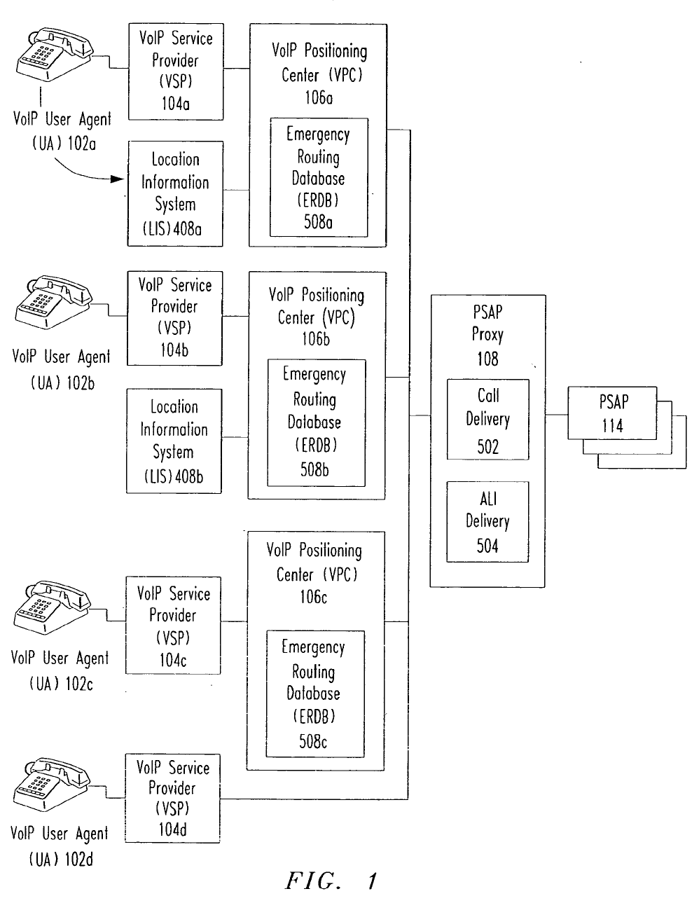

FIG. 1 shows implementation of a PSAP proxy 100 in an IP network, in accordance with the principles of the present invention.

In particular, as shown in FIG. 1, a network comprises multiple VoIP users 102a, 102b, 102c, 102d (collectively referred to herein as 102), serviced by a respective plurality of VoIP soft switches 104a, 104b, 104c, 104d (collectively referred to herein as 104).

Importantly, in accordance with the present invention, the conventional VoIP positioning center (VPC) is divided into a smaller, more efficient, less complex VPC 106a, 106b, 106c (collectively referred to herein as 106) capable only of route determination 508 (represented as 508a, 508b, 508c).

Also importantly, the invention implements the call delivery module 502 and provisioning list 504 remote from the VPC 106 in what is referred to herein as a “PSAP Proxy”. The VPCs 106 communicate with the PSAP Proxy 100 via an IP interface connected to a plurality of VPC modules. In this way, call delivery and PSAP provisioning lookup functions can be consolidated into a common location for use by a plurality of VoIP service providers.

The PSAP Proxy can be located within a VoIP service providers network, or because it is remote from the route determination module 508 of the VPC 106, the PSAP Proxy can be implemented as a commercial service provided by a third party to multiple VoIP service providers.

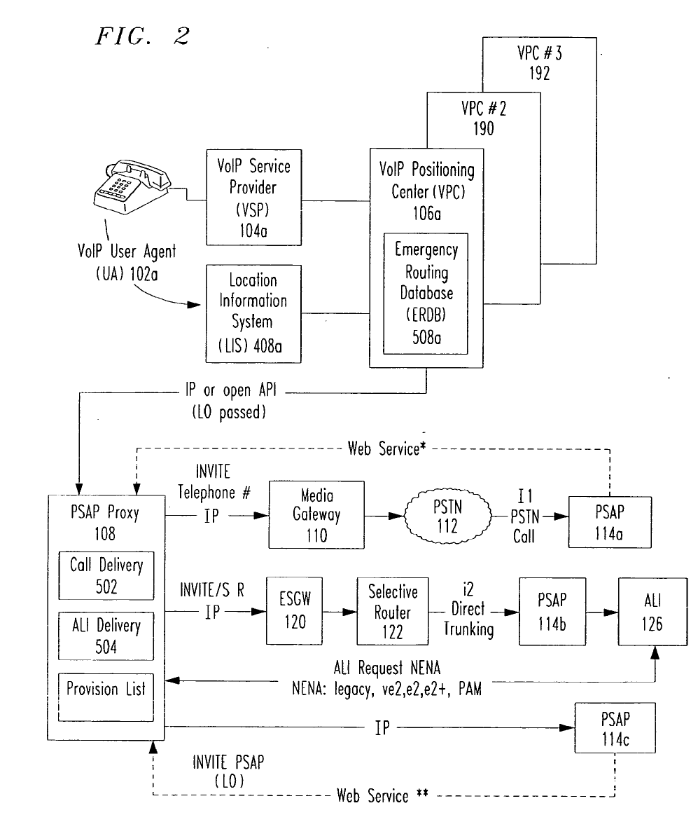

The VoIP positioning center (VPC) 106 selects the correct PSAP Proxy, based on a simple lookup of location object information with its designated PSAP. The VPC 106 then transmits the VoIP E911 call, with location object (LO) added, to the correct PSAP Proxy. Only one PSAP Proxy 100 is shown in FIGS. 1 and 2, but it will be understood by those of ordinary skill in the art that multiple PSAP Proxies may be implemented, either co-located or separately located.

The PSAP Proxy 100 makes all PSAPs 114 appear IP capable to VoIP service providers (VSPs), and provides a Session Initiation Protocol (SIP) Uniform Resource Identifier (URI) for all PSAPs 114.

The PSAP Proxy 100 communicates with any other components or entities required to process the call (e.g., ESGW, Selective Router, PSTN, PSAP).

FIG. 2 shows in more detail the implementation of a PSAP proxy 100 in an IP network as shown in FIG. 1.

In particular, as shown in FIG. 2, a VoIP user 102 is connected to the VoIP service provider's soft switch 104, which in turn communicates with a VoIP positioning center (VPC) 106. A location information server (LIS) 108 services the VPC 106. The LIS 108 is responsible for storing and providing access to the subscriber location information needed for E9-1-1 call processing (as defined by the NENA VoIP Location Working Group).

As shown in FIG. 2, when the VoIP user 102 dials 9-1-1, the VoIP Service Provider's soft switch 104 sends the 9-1-1 call to the voice positioning center (VPC) 106 for addition of a location object (LO).

Further as shown in FIG. 2, the PSAP Proxy 100 delivers the emergency 9-1-1 call, with location object added, to a correct PSAP 114 (collectively represented by PSAP 114a, 114b and 114c).

In a first scenario, the PSAP Proxy 100 passes the 9-1-1 call with location object added to the PSAP 114a using an INVITE telephone number message, via a media gateway 110 that translates between the IP protocol of the INVITE message and a telephone line interface, and interfaces with the public switched telephone network (PSTN) 112. In such case, the PSAP Proxy 100 serves as a web service automatic location identifier (ALI).

In a second scenario, the PSAP proxy 100 passes the 9-1-1 call with location object added to the PSAP 114b using an INVITE S/R message, via a ESGW 120 and selective router 122. In this scenario, the selective router 122 is connected to the relevant PSAP 114b via direct trunks.

In a third scenario, the PSAP proxy 100 passes the 9-1-1 call with location object added to the PSAP 114c using an INVITE PSAP [LO] message, via IP, to the PSAP proxy 114c. In such case, a web service for additional content delivery may be included such that the PSAP 114c may access the web service. Also, ALI data may be passed over the connection i3 between the PSAP proxy 100 and the PSAP 114c.

In all cases shown in FIG. 2 the location object preferably contains at a minimum one or more of the following: precise position (e.g., latitude/longitude), street address, or profile. The profile may comprise, e.g., a pre-defined location such as “home” or “work”, which in turn corresponds to a street address or lat/lon.

The PSAP proxy 100 then converts the INVITE message to the appropriate technology and protocol and sends to the PSAP along with the pertinent information (including, in some cases, the location object for IP-enabled PSAPs).

Currently there are three types of call access to a PSAP by an incoming emergency E911 VoIP call. Each PSAP 114 may have more than one type of call access: i1 type, i2 type, and/or i3 type.

i1 type call access for a PSAP is a common PSTN telephone line interface. i2 type call access for a PSAP relates to the use of a selective router/direct telephone trunk line. i3 type call access for a PSAP relates to a VoIP enabled PSAP.

Entry 401 gives an example associating a given PSAP, this one identified with a SIP/URI such as 911@kirkland.wa.gov, with a call access type of i1 (PSTN). Of course, PSAPs can be identified in other unique ways, such as by an assigned number as exemplified in entry 403. Moreover, as exemplified in entry 402, the PSAP might be provisioned with an i2 type of call access (i.e., selective router/direct trunk). Exemplified in entries 403-404 are PSAPs that are provisioned with i3 type call access, which are Internet Protocol (IP) interfaces that are VoIP enabled.

Most preferably, the interface between the VPC 106 and the PSAP Proxy 100 is an Internet Protocol (IP) connection such as the Internet. However, any open API may be implemented.

The PSAP Proxy communicates with any other components or entities required to process the call (e.g., ALI, Selective Router, PSTN, PSAP, VPC).

Advantages of the present invention include that it can be used to simplify the introduction or adoption of future technologies system-wide or on a PSAP by PSAP basis, by incorporating additional logic/capability in the PSAP Proxy rather than requiring changes by individual PSAPs, local exchange carriers (LECs), or VoIP service providers (VSPs). (The LEC is the wireline carrier for local calls.) The present invention moves call delivery outside the VoIP positioning center (VPC), simplifying the VPC and increasing flexibility of the system.

While the invention has been described with reference to the exemplary embodiments thereof, those skilled in the art will be able to make various modifications to the described embodiments of the invention without departing from the true spirit and scope of the invention.

### CONCLUSION

An early and favorable action of the merits is earnestly solicited.

What is claimed is:

1. A public safety access point (PSAP) call delivery device, comprising:
an Internet Protocol interface to receive an INVITE VoIP call with location object included; and
a call delivery module to forward said received INVITE VoIP call with location object included to a designated PSAP.

2. The public safety access point (PSAP) call delivery device according to claim 1, wherein:
said VoIP call is an emergency E-9-1-1 call.

3. The public safety access point (PSAP) call delivery device according to claim 1, wherein:
call delivery functions are consolidated into a common location for use by a plurality of VoIP service providers.

4. The public safety access point (PSAP) call delivery device according to claim 1, wherein:
said PSAP call delivery device is implemented as a third party commercial service to a VoIP service provider.

5. The public safety access point (PSAP) call delivery device according to claim 1, wherein:
said PSAP call delivery device is implemented as a third party commercial service to multiple VoIP service providers.

6. A method of delivering a voice over Internet Protocol (VoIP) emergency call to a public safety access point (PSAP), comprising:
determining a route of a VoIP emergency call;
passing an INVITE message including a location object relating to a caller of said VoIP emergency call over a connection utilizing an Internet Protocol (IP);
upon receipt of said passed INVITE message, determine said PSAP call access for said PSAP with said VoIP emergency call; and
delivering said INVITE message to said PSAP using an appropriate interface.

7. The method of delivering a voice over Internet Protocol (VoIP) emergency call to a public safety access point (PSAP) according to claim 6, wherein:
said appropriate interface is the Public Switched Telephone Network (PSTN).

8. The method of delivering a voice over Internet Protocol (VoIP) emergency call to a public safety access point (PSAP) according to claim 6, wherein:
said appropriate interface is to the Emergency Services Network over Selective Routers.

9. The method of delivering a voice over Internet Protocol (VoIP) emergency call to a public safety access point (PSAP) according to claim 6, wherein:
said appropriate interface is a connection utilizing an Internet Protocol.

10. Apparatus for delivering a voice over Internet Protocol (VoIP) emergency call to a public safety access point (PSAP), comprising:
means for determining a route of a VoIP emergency call;
means for passing an INVITE message including a location object relating to a caller of said VoIP emergency call over a connection utilizing an Internet Protocol (IP);
means for looking up the call access type of said PSAP for accessing said PSAP with said VoIP emergency call upon receipt of said passed INVITE message; and
means for delivering said INVITE message to said PSAP using an appropriate interface designated by said looked up call access type;
wherein an IP interface is interjected between route determination and VoIP call delivery.

11. The apparatus for delivering a voice over Internet Protocol (VoIP) emergency call to a public safety access point (PSAP) according to claim 10, wherein:
said appropriate interface is the Public Switched Telephone Network (PSTN).

12. The apparatus for delivering a voice over Internet Protocol (VoIP) emergency call to a public safety access point (PSAP) according to claim 10, wherein:
said appropriate interface is to the Emergency Services Network over Selective Routers.

13. The apparatus for delivering a voice over Internet Protocol (VoIP) emergency call to a public safety access point (PSAP) according to claim 10, wherein:
said appropriate interface is a connection utilizing an Internet Protocol.
